(19) United States
(12) Patent Application Publication
(10) Pub. No.: US 2016/0371892 A1
(43) Pub. Date: Dec. 22, 2016

(54) PARKING LOT MANAGEMENT

(71) Applicant: Robert Bosch GmbH, Stuttgart (DE)

(72) Inventors: Stefan Nordbruch, Kornwestheim (DE); Manuel Maier, Esslingen (DE)

(21) Appl. No.: 15/180,183

(22) Filed: Jun. 13, 2016

(30) Foreign Application Priority Data
Jun. 17, 2015 (DE) 10 2015 211 128.8

(51) Int. Cl. G07B 15/02; G06Q 50/10; G06Q 10/02; H04L 29/08; G08G 1/14

(52) U.S. Cl. CPC G07B 15/02; H04L 67/12; G08G 1/146; G06Q 10/02; G06Q 50/10

(57) ABSTRACT

A parking lot comprises multiple parking spaces, which are designed for parking respectively one motor vehicle. A method for managing the parking lot includes steps of scanning a parking space using a sensor assigned to the parking space, of determining that a motor vehicle is located in the parking space, of determining that the parked motor vehicle has no usage authorization for the parking space, and of outputting a notice.

### CROSS REFERENCE

The present application claims the benefit under 35 U.S.C. §119 of German Patent Application No. DE 102015211128.8 filed on Jun. 17, 2015, which is expressly incorporated herein by reference in its entirety.

### FIELD

The present invention relates to a parking lot management. The present invention relates in particular to the management of a parking lot having parking spaces for motor vehicles.

### BACKGROUND INFORMATION

A parking lot comprises multiple parking spaces, which are designed for accommodating respectively one motor vehicle. The parking lot may be located in the open or in an enclosed space, for example in a parking garage or in an underground parking lot. A parking lot sensor is mounted at each parking space, which is designed to determine whether or not a motor vehicle is present in the parking space. The sensor signal is transmitted to a processing device, which thereupon is able to prepare and output for example an occupancy map of the parking lot. Individual parking spaces may be reserved or rented on the basis of the occupancy map.

Usually, a parking space is rented for a specified time. If a motor vehicle has not left a rented parking space on time, then the occupancy map may deviate from reality. Furthermore, a motor vehicle that has been parked without authorization in one of the parking spaces must be treated in a suitable manner.

An objective of the present invention is to indicate a technology by which it is possible to deal with an incorrectly occupied parking space in a parking lot in a manner that is as expedient as possible.

### SUMMARY

A parking lot comprises multiple parking spaces, which are designed for parking respectively one motor vehicle. A method for managing the parking lot includes the steps of scanning a parking space using a sensor assigned to the parking space, of determining that a motor vehicle is located in the parking space, of determining that the parked motor vehicle lacks authorization to use the parking space, and of performing an action.

It is thus possible to deal jointly with motor vehicles that are parked incorrectly in different ways in the parking space of the parking lot. This facilitates the operation of the parking lot. This makes it easier to prepare a representation of the occupancy state of the individual parking spaces. The action may include in particular an output of a notice. The notice may be alternatively directed to a driver of the motor vehicle, to service personnel, an office such as the police or an automatic component such as an alarm system.

Preferably, a license plate of the motor vehicle is scanned and the notice is assigned to the license plate.

This makes it possible on the one hand to associate the rule violation with the motor vehicle in the parking space such that for example a claim for damages may be directed to the correct destination. In another specific embodiment, through the association with the license plate, the notice may be made accessible to a driver, who is associated with the license plate. The driver is thus able to be notified early if his motor vehicle occupies a parking space in a manner contrary to rules. If the rule infringement is associated for example with a supplementary payment or an increased rental fee, then the message may provide information earlier and more clearly as to which rule was infringed and what possible sanctions are associated with it.

In another specific embodiment, a determination is made that the parked vehicle exceeded a predetermined usage period of the parking space. This makes it possible to treat an exceedingly long usage of the parking space differently than for example the parking of a motor vehicle in a parking space without an appropriate rental agreement. It is thus possible to motivate drivers of motor vehicles that are parked in the parking lot to adhere to the rules.

It is also possible automatically to extend a booking of the parking space for the motor vehicle. Additional costs may be associated with the booking process, the additional costs being incurred immediately in one specific embodiment, for example by an automatic booking. If the automatic extension is not available or if the booking fails, then additional steps may be initiated that may result in the motor vehicle being removed for example.

In another specific embodiment, a determination is made that the parking space is not released for usage. A penalty may be issued immediately for this form of unauthorized occupancy.

The notice may be directed to service personnel. The service personnel may be instructed for example to take further measures. These may include for example notifying law enforcement forces (police), legal action or ordering a towing service.

It is furthermore preferred that the unauthorized usage of the parking space is documented. For this purpose, a camera image may be produced for example. A current time may be associated with the camera image in order to record the time of the rule violation.

It is furthermore preferred that the removal of the motor vehicle from the parking space is effected, it being possible in particular to notify a towing service automatically. In this manner, the parking lot may be operated smoothly and without increased personnel.

A computer program product includes program code for carrying out the method described above when the computer program product is run on a processing device or is stored on a computer-readable data carrier.

A control unit for managing a parking lot includes a sensor assigned to the parking space and a processing device, which is designed to determine, on the basis of a sensor signal, that a motor vehicle is located in the parking space, that the parked motor vehicle has no usage authorization for the parking space, and to output a notice.

The control unit preferably also includes a camera that is designed to document the usage of the parking space.

### BRIEF DESCRIPTION OF THE DRAWINGS

The present invention will now be described in more detail with reference to the figures.

FIG. 1 shows a parking lot including a management device.

FIG. 2 shows a flow chart of a method for managing the parking lot from FIG. 1.

### DETAILED DESCRIPTION OF EXAMPLE EMBODIMENTS

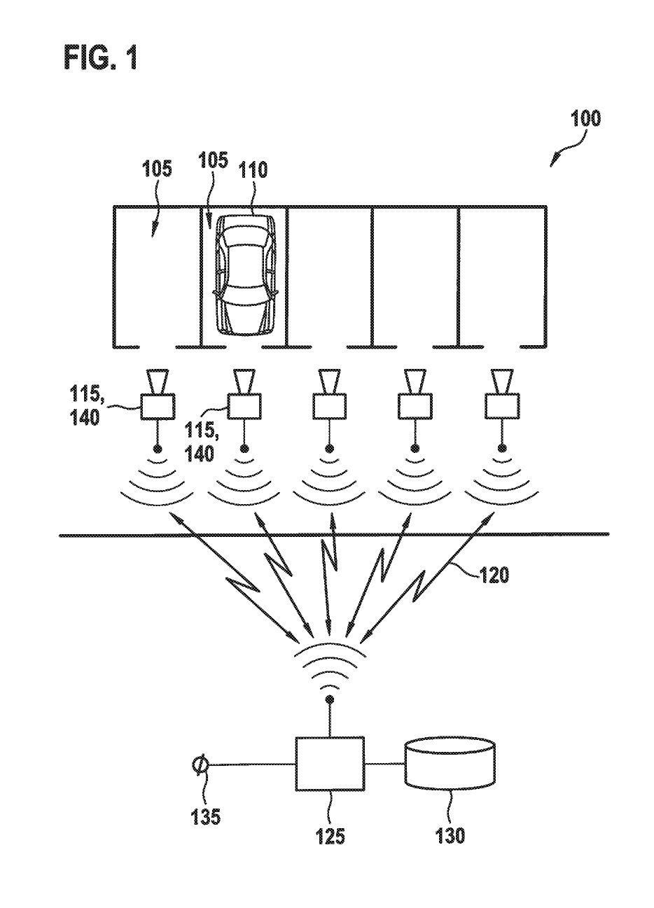

FIG. 1 shows a parking lot 100 having multiple parking spaces 105, which are designed for parking respectively one motor vehicle 110. Parking lot 110 maybe in the open or in an enclosed space, for example in a parking garage or an underground parking facility. A parking sensor 115 is assigned to each parking space 105, which is designed to perform a scan to determine whether or not a motor vehicle 105 is located in parking space 105.

In different specific embodiments, parking sensor 115 may follow different physical principles and may be implemented for example by radar, lidar, ultrasound, a photoelectric barrier, an optical camera, a capacitive sensor or in another manner, in particular also as a combination of multiple principles. Parking sensor 115 may also be disposed below motor vehicle 110, above it or at half height. Furthermore, a parking sensor 115 may also be assigned to multiple parking spaces 105, it being preferred that it is possible to scan each parking space 105 separately. Parking sensors 115 are connected to a processing device 125 via a communication network 120. Communication network 120 may alternatively be wireless, wired or a combination of both technologies.

Processing device 125 is preferably connected to a memory device 130 that is designed to store which parking spaces 105 should be occupied by motor vehicles 110 and which should not. The requested occupancy state may derive in particular from a booking or reservation system that allows the driver of a motor vehicle 110 to rent a parking space 105 for his motor vehicle 110 when entering parking lot 100 or already at an earlier point in time. Additional information, for example for charging for rented parking spaces 105, may likewise be stored in memory device 130. Processing device 125 is designed to check, using the parking sensor(s) 115, which parking spaces 105 are occupied by motor vehicles 110 and whether these are authorized to park in the respective parking space 105. If an irregularity is determined, then a series of measures may be taken, which includes in particular the output of a message, for example via an interface 135. In addition it is possible to document the occupancy of parking space 105 by motor vehicle 110. For this purpose, for example, a camera 140 may be provided that is mounted in the area of parking space 105. In the specific embodiment illustrated, camera 140 is implemented so as to be integrated with parking sensor 115. In one variant, camera 140 may also provide an automatic detection of an identification of a motor vehicle 110 in interaction with processing device 125, for example a representation of the official license plate of motor vehicle 110.

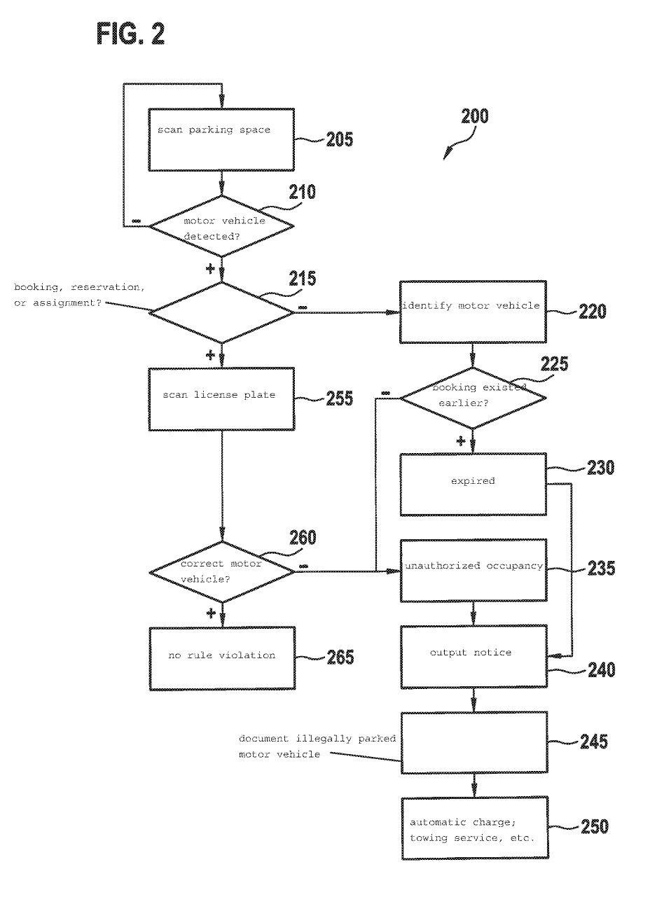

FIG. 2 shows a flow chart of a method 200 for managing the parking lot 100 from FIG. 1. Method 200 is particularly designed to be executed on processing device 125. To facilitate understanding, method 200 is described in the following with reference to only one single parking space 105.

In a first step 205, parking space 105 is scanned, for example using parking sensor 115. Subsequently, a check is performed in a step 210 as to whether a motor vehicle 110 was detected in parking space 105. If this is not the case, method 200 may branch back to step 205 and run through again.

Otherwise, a determination may be made in a step 215 as to whether a booking, a reservation or another assignment of parking space 105 to a motor vehicle 110 exists. This information may be retrieved in particular from memory device 130.

If no booking exists, then it is possible to provide in a step 220 an identification of motor vehicle 110, for example by detecting the official license plate. Subsequently, in a step 225, a differentiation may be made as to whether for motor vehicle 110 a booking existed for an earlier point in time for parking space 105. In this case, it is possible to detect in step 230 that a parking time for motor vehicle 110 in parking space 105 has expired.

Otherwise, if no earlier usage for motor vehicle 110 is known, an unauthorized occupancy of parking space 105 may be determined in a step 235.

Both in the case of the expired parking time of step 230 as well as in the case of the unauthorized occupancy of step 235, one or multiple measures may be taken. In particular, a notice about the detected circumstance may be output in a step 240. The notice may be output both to a driver of motor vehicle 110 as well as to service personnel. In another specific embodiment, the notice is output publicly, for example directly at parking space 105. In a step 245, which is independent of the aforementioned step, it is also possible to document motor vehicle 110 being illegally parked in parking space 105, for example by one or multiple photographs by camera 140. In addition, another measure may be taken in a step 250 such as for example an automatic charge of an increased parking fee, notification of a towing service, etc.

If it is determined in step 215 that a booking exists, then the license plate of motor vehicle 110 may again be scanned in a step 255. This step may correspond in particular to step 220. Subsequently, a determination may be made in a step 260 as to whether the motor vehicle 110 parked in parking space 105 is the vehicle for which a booking of parking space 105 exists. If this is not the case, then an unauthorized occupancy is established, and method 200 may proceed with step 235. Otherwise, a determination is made in a step 265 that no rule violation exists. Method 200 may subsequently return to the beginning and run through again.

What is claimed is:

1. A method for managing a parking lot having multiple parking spaces, which are designed for parking respectively one motor vehicle, the method comprising:
scanning a parking space using a sensor assigned to the parking space;
determining that a motor vehicle is located in the parking space;
determining that the parked motor vehicle has no usage authorization for the parking space; and
performing an action.

2. The method as recited in claim 1, wherein a license plate of the motor vehicle is scanned and a notice is assigned to the license plate.

3. The method as recited in claim 1, wherein a determination is made that the motor vehicle located in the parting space has exceeded a predetermined usage time of the parking space.

4. The method as recited in claim 3, wherein a booking of the parking space is automatically extended for the motor vehicle.

5. The method as recited in claim 1, wherein a determination is made that the parking space is not released for any usage.

6. The method as recited in claim 2, wherein the notice is directed to service personnel.

7. The method as recited in claim 1, wherein a documentation of the usage of the parking space is prepared.

8. The method as recited in claim 1, wherein a removal of the motor vehicle from the parking space is effected.

9. A computer-readable data carrier storing program code for managing a parking lot having multiple parking spaces, which are designed for parking respectively one motor vehicle. the program code, when executed by a processing device, causing the processing device to perform:
scanning a parking space using a sensor assigned to the parking space;
determining that a motor vehicle is located in the parking space;
determining that the parked motor vehicle has no usage authorization for the parking space; and
performing an action.

10. A control unit for managing a parking lot having multiple parking spaces, which are designed for parking respectively one motor vehicle, the control unit including:
a sensor assigned to the parking space;
a processing device, which is designed to determine, on the basis of a signal from the sensor, that a motor vehicle is located in the parking space, that the motor vehicle in the parking space has no usage authorization for the parking space, and to output a notice.

11. The control unit as recited in claim 10, further comprising:
a camera designed to document the usage of the parking space.
